(19) United States
(12) Patent Application Publication
(10) Pub. No.: US 2006/0175773 A1
(43) Pub. Date: Aug. 10, 2006

(54) Adapter for impact rotary tool

(75) Inventors: Kim Y.C. Tsai, Taichung Hsien (TW); Cheng-I Teng, Taichung County (TW)

Correspondence Address: BACON & THOMAS, PLLC, 625 SLATERS LANE, FOURTH FLOOR, ALEXANDRIA, VA, 22314, US

(73) Assignee: MOBILETRON ELECTRONICS CO., LTD., TAICHUNG HSIEN (TW)

(21) Appl. No.: 11/052,779

(22) Filed: Feb. 9, 2005

(51) Int. Cl. B23B 31/02

(52) U.S. Cl. 279/143

(57) ABSTRACT

An adapter for connecting between an output head of an impact rotary tool and a tool bit includes a body, which has a first end wall, a second end wall opposite to the first end wall, a square hole axially extending from the first end wall toward the second end wall for coupling to the output head of the impact rotary tool, and a hexagonal hole axially extending from the second end wall toward the first end wall in alignment with the square hole for holding the tool bit, and a magnet mounted inside the body adjacent to the hexagonal hole for securing the tool bit in the hexagonal hole by magnetic attraction.

### BACKGROUND OF THE INVENTION

1. Field of the Invention

The present invention relates to an impact rotary tool and more specifically, to an adapter used in an impact rotary tool for holding a screwdriver head or screwdriver bit.

2. Description of the Related Art

An electric or air-driven impact rotary tool must be used with a tool bit adapter to hold a tool bit for working. A tool bit adapter for this purpose has a square hole and a polygonal hole. The square hole and the polygonal hole have a respective opening respectively formed in the two distal end walls of the tool bit adapter. The square hole is connectable to the square output head of an impact rotary tool. The polygonal hole is adapted to hold a tool bit, for enabling the tool bit to be rotated with the tool bit adapter and the square output head of the impact rotary tool to which the tool bit adapter is connected.

Because the output head of an impact rotary tool has a square profile, a tool bit cannot be directly fastened to the output head, and an adapter must be used to connect a tool bit to the output head. However, according to the aforesaid conventional tool bit adapter, the installed tool bit may vibrate or fall from the hexagonal hole of the tool bit adapter during the operation of the impact rotary tool.

### SUMMARY OF THE INVENTION

The present invention has been accomplished under the circumstances in view. It is one object of the present invention to provide a tool bit adapter, which is connectable to the square output head of an impact rotary tool to hold a screwdriver head (screwdriver bit), for enabling the screwdriver head (screwdriver bit) to be rotated with the square output head of the impact rotary tool smoothly without vibration.

To achieve this object of the present invention, the adapter for connecting between a tool bit and an output head of an impact rotary tool comprises a body and a magnet. The body has a first end wall, a second end wall opposite to the first end wall, a square hole axially extending from the first end wall toward the second end wall for coupling to the output head of the impact rotary tool, and a hexagonal hole axially extending from the second end wall toward the first end wall in alignment with the square hole for holding the tool bit. The square hole has a caliber greater than that of the hexagonal hole. The magnet is mounted inside the body adjacent to the hexagonal hole for securing the tool bit in the hexagonal hole by magnetic attraction.

### BRIEF DESCRIPTION OF THE DRAWINGS

FIG. 1 is a plain view of a tool bit adapter according to a preferred embodiment of the present invention.

FIG. 2 is a front view of FIG. 1.

FIG. 3 is a rear view of FIG. 1.

FIG. 4 is a sectional view taken along line 4-4 of FIG. 2.

FIG. 5 is schematic view showing the use of the tool bit adapter according to the present invention.

FIG. 6 is a sectional view of a part of FIG. 5.

### DETAILED DESCRIPTION OF THE INVENTION

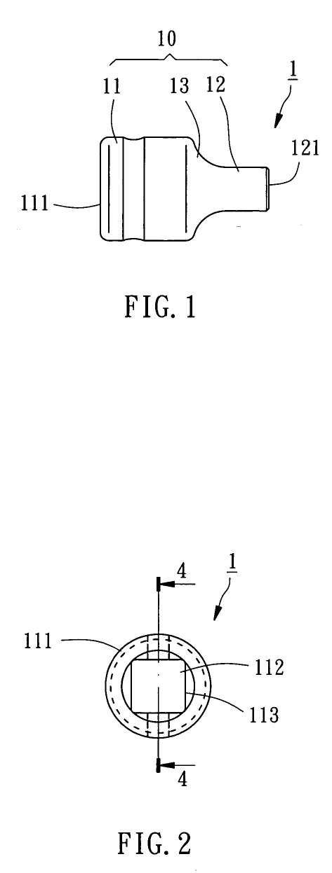

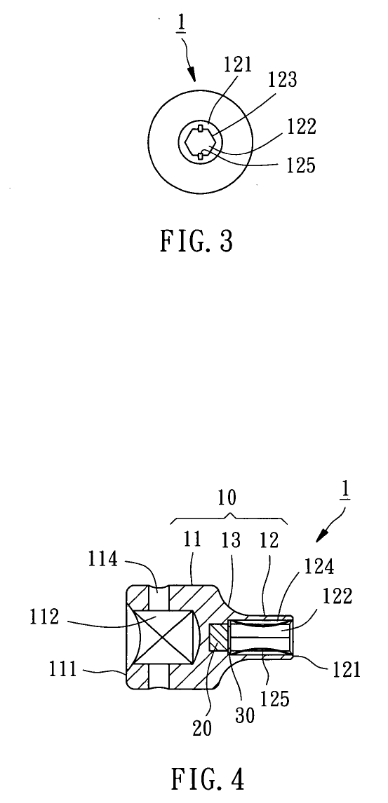

Referring to FIGS. 1-4, a tool bit adapter 1 in accordance with the preferred embodiment of the present invention is shown comprising an adapter body 10, and a magnet 20.

The adapter body 10 is a cylindrical member having a cylindrical base 11, a neck 12, a shoulder 13 connected between the base 11 and the neck 12, a first end wall 111 at the back side of the base 11 opposite to the shoulder 13 and the neck 12, a second end wall 121 at the front side of the neck 12 opposite to the base 11, a square hole 112 formed inside the base 11, a hexagonal hole 122 longitudinally formed in the neck 12, a square opening 113 formed in the first end wall 111 in communication with the square hole 112, a hexagonal opening 123 formed in the second end wall 121 in communication with the hexagonal hole 122, two inside grooves 124 longitudinally formed in the periphery wall of the hexagonal hole 122 at two sides to accommodate a respective arched spring strip 125, and two through holes 114 transversely extending through the base 11 in communication with the square hole 112 and aligned in a line. The caliber of the rectangular hole 112 is greater than the hexagonal hole 122.

The magnet 20 is shaped like a short hexagonal prism fitted into the inside of the hexagonal hole 122 and secured to the bottom end of the hexagonal hole 122 by a C-shaped retainer 30.

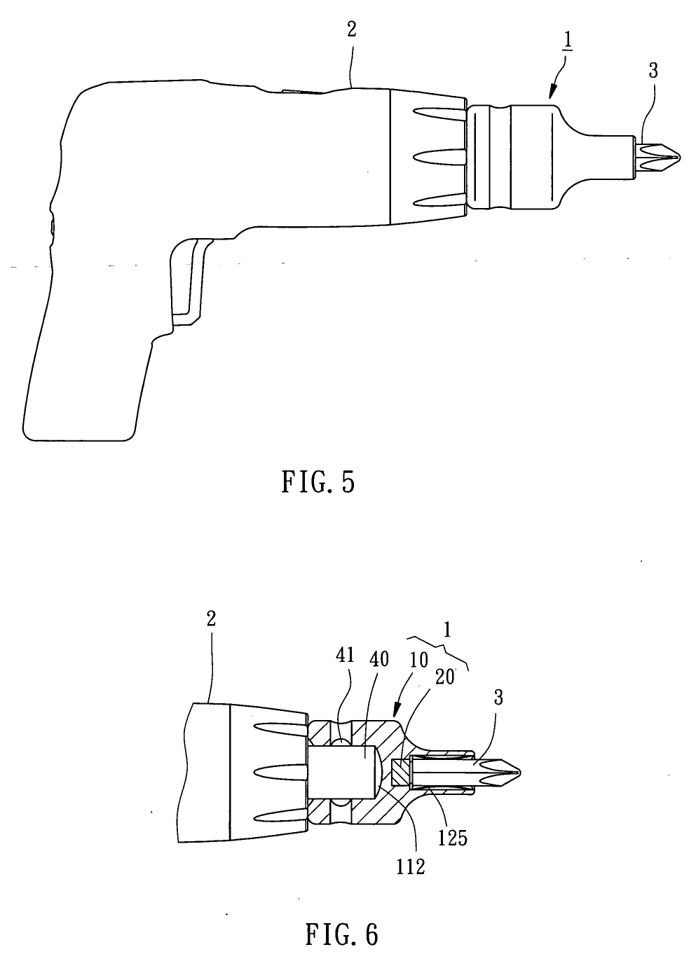

Referring to FIGS. 5 and 6, the square hole 112 of the tool bit adapter 1 is coupled to the square output head 40 of an impact rotary tool 2, and the hexagonal hole 122 of the tool bit adapter 1 holds a screwdriver head or screwdriver bit 3. After connection of the square hole 112 of the tool bit adapter 1 to the square output head 40 of the impact rotary tool 2, the retaining spring pins 41 of the square output head 40 are respectively engaged into the through holes 114 of the tool bit adapter 1 to lock the tool bit adapter 1 to the square output head 40. Further, after insertion of the screwdriver head (screwdriver bit) 3 into the hexagonal hole 122 of the tool bit adapter 1, the magnet 20 secures the screwdriver head (screwdriver bit) 3 in place by means of magnetic attraction, and the two arched spring strips 125 are pressed against the periphery of the screwdriver head (screwdriver bit) 3 to hold down the screwdriver head (screwdriver bit) 3 against vibration. When starting the impact rotary tool 2, the tool bit adapter 1 and the screwdriver head (screwdriver bit) 3 are rotated with the square output head 40 of the impact rotary tool 2 smoothly.

What is claimed is:

1. An adapter for connecting between a tool bit and an output head of an impact rotary tool, said adapter comprising:
a body having a first end wall, a second end wall opposite to said first end wall, a square hole axially extending from said first end wall toward said second end wall for coupling to the output head of the impact rotary tool, and a hexagonal hole axially extending from said second end wall toward said first end wall in alignment with said square hole for holding the tool bit, said square hole having a caliber greater than that of said hexagonal hole; and
a magnet mounted inside said body adjacent to said hexagonal hole.

2. The adapter as claimed in claim 1, wherein said body comprises a cylindrical base, a neck, and a shoulder connected between said cylindrical base and said neck; said first end wall is located at one end of said cylindrical base opposite to said shoulder and said neck; said second end wall is located at one end of said neck opposite to said cylindrical base; said square hole and said hexagonal hole are respectively formed in said cylindrical base and said neck.

3. The adapter as claimed in claim 2, wherein said body further comprises two inside grooves longitudinally formed in a periphery wall of said hexagonal hole at two sides, two arched spring strips respectively mounted in said inside grooves for holding down the tool bit inserted in said hexagonal hole, and two through holes transversely extending through said cylindrical base in communication with said square hole at two sides for receiving two retaining spring pins of the square output head of the impact rotary tool.

4. The adapter as claimed in claim 1, further comprising a C-shaped retainer fastened inside said hexagonal hole of said body for securing said magnet in said hexagonal hole.
